(19) United States
(12) Patent Application Publication
(10) Pub. No.: US 2019/0190190 A1
(43) Pub. Date: Jun. 20, 2019

(54) CABLE JOINT ARTICULATED EXTENSION PIECE FOR A CONNECTOR INTENDED TO BE LINKED TO AT LEAST ONE CABLE

(71) Applicant: RADIALL SA, Aubervilliers (FR)

(72) Inventors: Fabien BOURGEAS, Saint Nicolas de Macherin (FR); Domenico LOMUSCIO, Sillans (FR); Vivien BADIQUE, Wettolsheim (FR); Benoit DUPEUX, Vatilieu (FR)

(21) Appl. No.: 16/218,880

(22) Filed: Dec. 13, 2018

(30) Foreign Application Priority Data
Dec. 15, 2017 (FR) 17 62297

(51) Int. Cl. H01R 13/52; H02G 3/06; G02B 6/44

(52) U.S. Cl. CPC H01R 13/5221; G02B 6/4459; H02G 3/06

(57) ABSTRACT

The present application relates to a connector extension piece with a cable joint at the end thereof distanced from the cable, the extension piece being articulated using at least one ball joint inside which the cable is protected mechanically and against the conditions of the outside environment.

The present application claims priority to and incorporates by reference the entire contents of French Patent Application No. 1762297 filed in France on Dec. 15, 2017.

### TECHNICAL FIELD

The present invention relates to the field of electrical and/or data transmission connector technology.

The aim of the invention is to shift a cable joint from the rear part of a connector body to which it is usually directly fixed. This cable joint may be of the gland, heat-shrinkable or heat-sealing sheath, elastomer sleeve, overmolding type, for example.

More particularly, it therefore relates to a cable joint articulated extension piece for a connector intended to be linked to at least one cable supporting contacts.

The invention is used more generally for any type of connector technology for transmission of electrical signals and/or data and/or radiofrequency (RF) signals and/or optical signals.

The invention is used particularly for a connector plug intended to be mounted on at least one cable supporting one or more contracts, and to be connected to a receptacle of a housing panel of a piece of electronic equipment.

These contacts may be of RJ45, power, data, combined or optical type. These contacts can, in particular, be an SFP/SFP+/QSFP/QSFP+ optoelectronic converter interface, or optical contacts.

The plugs in question in particular are those for connecting to the receptacles of pieces of electronic equipment which use several optical and/or electrical pathways with connections, that are found in the outside environment and/or under harsh conditions particularly in telecommunication facilities such as mobile phone towers, in the domestic or industry high-speed data transmission networks, in the networks of surveillance cameras or even for the transmission of data in railway facilities.

### PRIOR ART

In the field of the connector technology for transmitting electrical signals and/or data and/or radiofrequency (RF) signals and/or optical signals, connectors having central contacts each intended to be linked to a wire or to a contact of a cable, are known.

These connectors may be subjected to outside environments that may involve high levels of strain, both in terms of temperature and moisture and in terms of mechanical stresses, particularly during installation or available space.

This is particularly the case between a plug mounted on a cable that is to be connected to a corresponding receptacle in the majority of the pieces of electronic equipment intended to be installed in an outside environment.

Various solutions are already known to mechanically protect and/or seal the ends of the cables mounted on the connectors.

In this case, it is possible to firstly mention the thermoplastic material flexible-sheath portions fitted around the end of the cable and the rear part of the connector body to which the cable is linked. This solution of a sheath that is solely fitted is not at all satisfactory since it does not in fact produce any mechanical protection of the contacts in the case of a pulling force on the cable, which is very common during connection or after during the life of the connector.

Such a sheath may be overmolded around the cable and the connector body. With an overmolded sheath, the level of mechanical retention of the cable remains insufficient such that in the case of mechanical stress via pulling force, the contacts may be easily damaged.

HDMI connectors are also known which are in two parts that are articulated to one another via a mutual pivot link, which makes it possible to partially accompany the cable or the internal flexible circuit when the latter is bent. This type of articulated connector neither makes it possible to have good level of sealing, nor to produce effective retention when the cable is pulled.

Furthermore, all of these solutions according to the prior art have substantial disadvantages.

Firstly, none of these solutions makes it possible to achieve mounting with mechanical protection and sealing, in situ, i.e. on the site of the facility or electronic equipment for which the connector is intended.

Furthermore, none of them makes it possible to properly control the radius of curvature which may be imposed upon the cable when mounting in situ.

Yet, in some configurations, particularly of limited available space, an operator may unintentionally curve the cable which may be detrimental to the transmission of signals, in particular optical signals, or be harmful to the integrity of the contacts.

Finally, regardless of the current solution, the cable is not in fact mechanically protected against squashing which may occur in situ.

As a result, there is a need to improve the solutions for mounting connectors to cables for transmitting electrical signals and/or data and/or RF signals, particularly such as to mechanically protect the end of the cables and the possible contacts thereof and those of the connectors, regardless of the types of mechanical stresses to which they may be subjected, while ensuring sealing with respect to the outside environment.

The aim of the invention is to at least partially meet this need.

### DISCLOSURE OF THE INVENTION

To this end, the invention relates to a device forming a cable joint extension piece for a connector intended to be linked to at least one electrical and/or optical cable, the device comprising:
a first component comprising a cable joint part forming a conduit suitable for a cable to pass therethrough in a sealed manner while protecting the cable with regard to the outside, and an articulated part made up by a sphere portion formed integrally or fixed to the conduit of the cable joint,
a second component comprising a connector joint part suitable to be formed integrally or fixed with a connector body and an articulation part made up by a sphere portion formed integrally or fixed to the connector joint part.

In the extension piece according to the invention:
the sphere portions of the first and second components each internally define a through-passage for the cable;
the sphere portions of the first and of the second component are each assembled by fitting with a complementary sphere portion of a component of the extension piece, such as to produce at least one ball joint between the cable joint part of the first component and the connector joint part of the second component.

According to an advantageous embodiment, the cable joint part is configured as a gland of the extension piece.

Thus, the invention essentially consists in defining a connector extension piece with a cable joint at the end thereof distanced from the cable, the extension piece being articulated using at least one ball joint inside which the cable is protected mechanically and against the conditions of the outside environment.

Thus, the length of the extension piece may be perfectly variable depending on the needs as a function of the constituent number of elements thereof.

The cable joint is configured to firstly provide perfect sealing with respect to the outside.

The diameter of the through-passages inside the various components of the extension piece and therefore of the cable joint may be sufficiently large for passage of the majority of the types of existing signal interfaces, for example of optical, power, data, combined, RJ45, LC Duplex, LC simplex, MPO, USB type, etc.

The cable diameters which may pass through the extension piece may vary widely, for example in a range of 4 to 11.5 mm.

The cable joint part is advantageously configured as a gland of the extension piece in order to be able to:
guarantee sealing complying with the IP65, IP67, IP68, or UL50E standard,
be easily completed in situ,
guarantee a high cable retention force, typically from 150 N to 250 N, with a tightening torque of 2.5 Nm that may be achieved manually.

Thanks to the invention, the winding/curvature diameter of the cable linked to the connector is controlled, and this guarantees mechanical protection of the cable, particularly when being pulled, and of the central contacts of the connector and, where applicable, of those of the cable.

Moreover, the cables and contacts are protected against squashing, since all of the components of the extension piece may be sufficiently rigid to resist this type of effort.

Thus, this guarantees the transmission of electrical and/or optical signals by the cable.

Furthermore, the extension piece according to the invention makes it possible to orientate, as desired according to all orientations, the cable at the outlet of a piece of electronic equipment. The alternative where it is possible to partially block the spheres with respect to one another makes it possible to rotationally immobilize the balls and therefore the path followed by the cable.

The extension piece according to the invention is completely modular and it is possible to add as many third components, i.e. protections for the cable with ball joints, as desired. Each addition of an extra component consists in force-fitting one sphere portion into another of a component.

The cable length spanned by the extension piece may therefore be adapted as desired according to the various configurations of facilities or electronic equipment to which the connectors are linked. This is advantageous particularly in the case of existing facilities or equipment.

According to an advantageous alternative embodiment, the cable joint part of the first component comprises, on the outer periphery thereof, a threading for screwing on the locking ring of the cable joint.

According to another advantageous alternative embodiment, the connector joint part of the second component comprises, on the inner periphery thereof, a threading for screwing the second component directly onto the connector body.

According to an embodiment, the sphere portions of the first and of the second component may be assembled by fitting directly with one another.

Alternatively, the extension piece may comprise at least one third component comprising at least two articulation parts which are each made up by a sphere portion formed integrally or fixed to one another, the sphere portion of the first component being assembled by fitting directly with a sphere portion of at least one third component in order to form a ball joint, the sphere portion of the second component being assembled by fitting directly with a sphere portion of at least one third component in order to form another ball joint.

The third component may comprise at least three articulation parts linked to one another by a linking part.

The linking part may have the general shape of a Y.

According to an embodiment, the extension piece comprises at least two third components, a sphere portion of one of the third components being assembled by fitting directly with a sphere portion of another of the third components in order to form another ball joint.

Advantageously, at least one sphere portion is made up of at least two spherical caps assembled together with a seal arranged inside the assembly thereof.

According to a first variant, each of the two spherical caps may comprise latching protuberances and/or hollows, such as to mutually assemble the caps by latching.

According to a second variant, each of the two spherical caps may comprise threads, such as to mutually assemble the caps by screwing.

Advantageously, one of the two spherical caps, under the form of a ring, comprises a locking notch adapted to cooperate by notching with at least one complementary relief formed in the other of the two spherical caps, so as to lock the screwing, and whatever the rotation of the assembled ball joint.

Preferably, the ring is split.

According to a first alternative, two sphere portions assembled directly with one another by means of fitting being further suitable to rotate freely with respect one another.

According to a second alternative, two sphere portions assembled directly with one another by means of fitting further comprising protuberances and/or hollows for rotational blocking, such as to have a rotation blocked according to a given angle of one sphere portion with respect to the other.

All of the components of the extension piece are preferably made from electrically insulating material, preferably again from the same material as that of the connector body.

Another subject matter of the invention is a connector, intended to be linked to at least one cable, comprising a body formed integrally or fixed to the connector joint part of the second component of an extension piece as described above.

The connector may be intended to be connected to two cables or two separate groups, in combination with a Y-shaped linking part extension piece, an articulation part of a third component being assembled directly with the joint part of the second component while being crossed by the two cables or separate cable groups, while each of the other two articulation parts forming the arms of the Y of the third component is crossed by one of the two cables or separate cable groups.

Another subject matter of the invention is a set of connectors, comprising a plurality of connectors as above, comprising a sheath covering all or some of the components of all of the extension pieces.

The set may comprise at least two connectors in combination with a Y-shaped linking part extension piece, an articulation part of a third component being crossed by a single cable or a single group of cables, while each of the other two articulation parts forming the arms of the Y of the third component is assembled directly with the joint part of the second component of one of the connectors, while being crossed by a part of the single cable or of the single group of cables.

This alternative according to the invention with a Y-shaped component makes it possible to protect and separate hybrid cables, i.e. with mixed signal transmission wires, for example RJ45 signal transmission wires separated from power wires, fiber optics separated from power wires, data transmission wires separated from power wires. This alternative is not limited to two connectors to be linked to a cable, or two cables to be linked to a connector, but to multiple connectors or cables.

The invention also relates, according to another of the aspects thereof, to a method for in situ mounting of a connector with an extension piece described above, on at least one cable, comprising the following steps:
a. threading the cable or cables inside the components of the extension piece;
b. connecting the central contacts of the cable with those of the connector;
c. where required, fixing the joint part of the second component to the body of the connector;
d. producing the cable joint using the cable joint part of the first component of the extension piece.

Step a. is carried out with the components of the extension piece having already been assembled by means of fitting therebetween, or not.

### DETAILED DESCRIPTION

Other advantages and features of the invention will emerge more clearly upon reading the detailed description of examples of implementing the invention, said description being given by way of illustration and in a nonlimiting manner with reference to the following figures wherein:

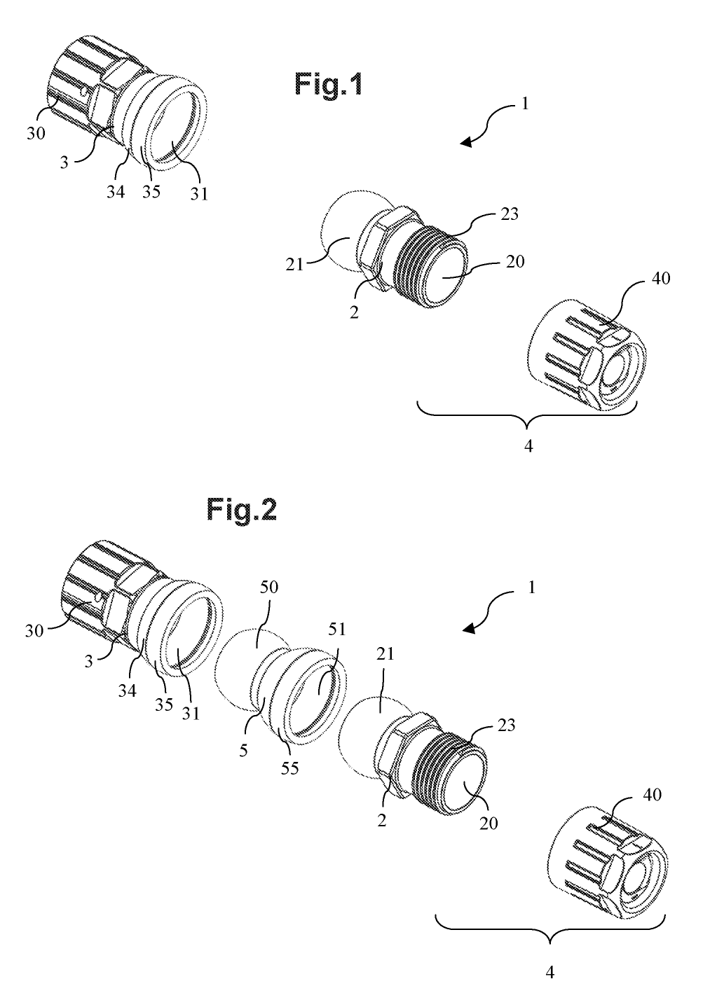

FIG. 1 is an exploded perspective view of an example of a connector extension piece with a gland according to the invention;

FIG. 2 is an exploded perspective of an advantageous alternative of the connector extension piece with a gland according to the invention;

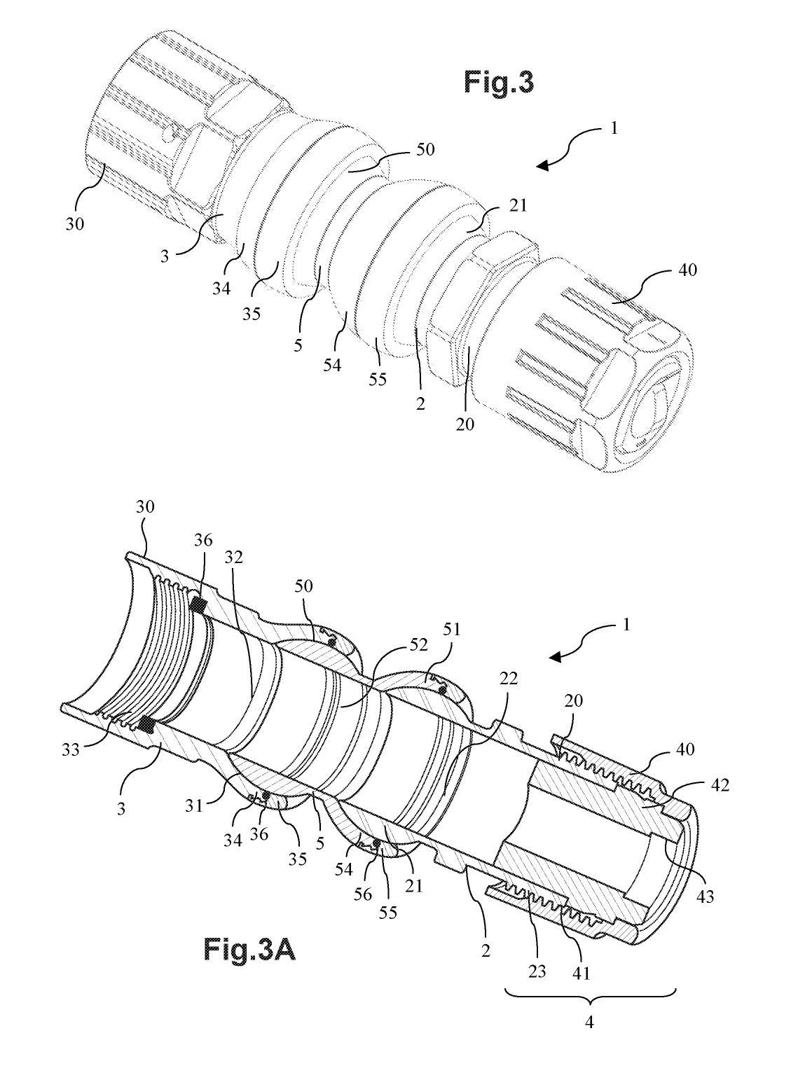

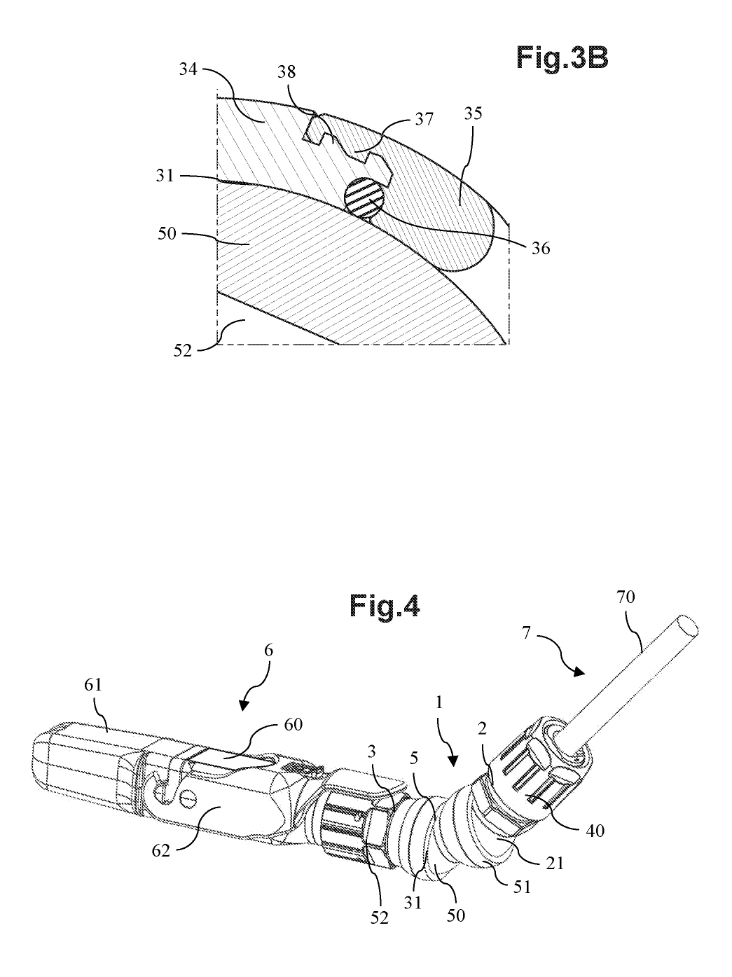

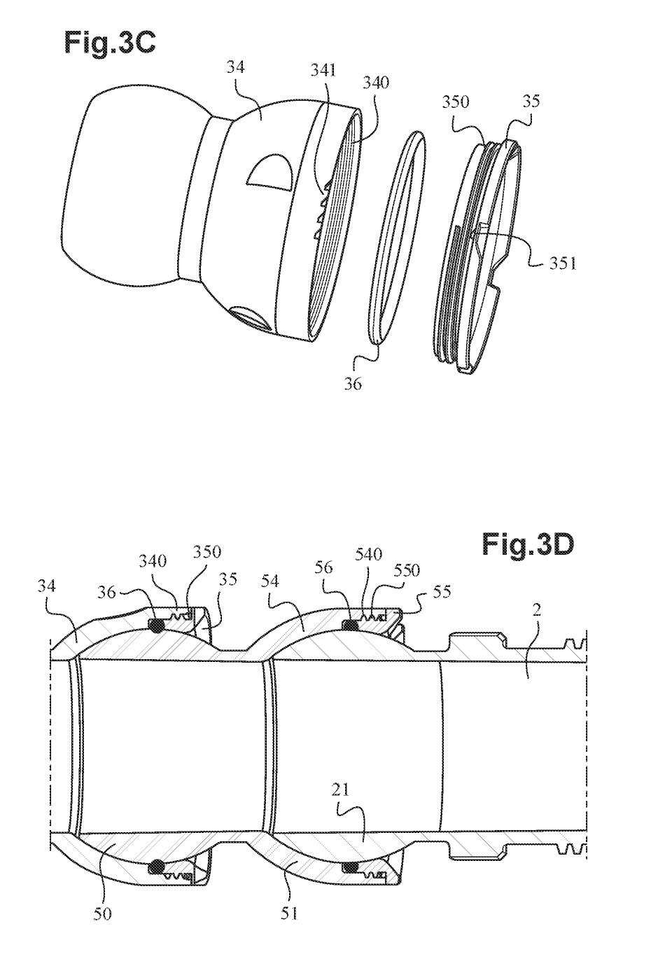

FIG. 3 is a perspective view of the extension piece according to FIG. 2 once assembled and with the gland fixed on the extension piece;

FIG. 3A is a view of a longitudinal section of FIG. 3;

FIG. 3B is a sectional view of an enlarged detail of FIG. 3A;

FIGS. 3C and 3D are respectively exploded and longitudinal cross-section views of a variant of assembling of an extension piece according to the invention;

FIG. 4 is a perspective view of a connector linked to a cable and on which an extension piece with the gland thereof according to FIGS. 3 to 3B is fixed;

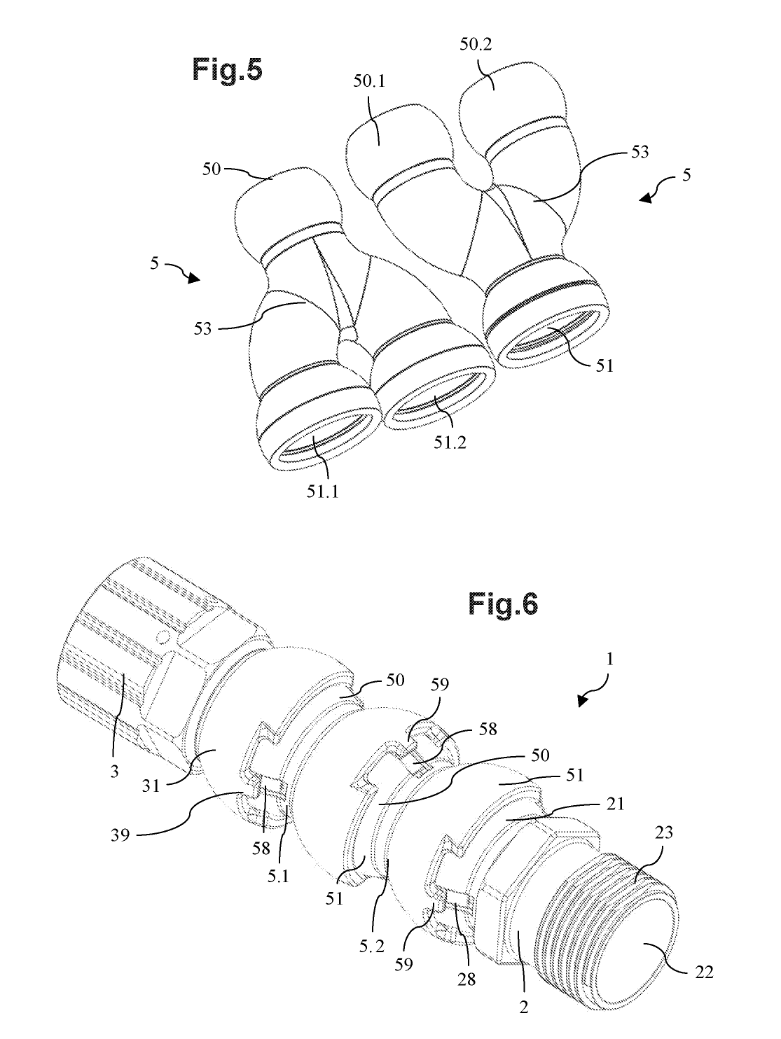

FIG. 5 is a perspective view of an advantageous Y-shaped alternative of a component of the extension piece according to the invention;

FIG. 6 is a perspective view of an alternative of the extension piece according to FIGS. 3 to 3B;

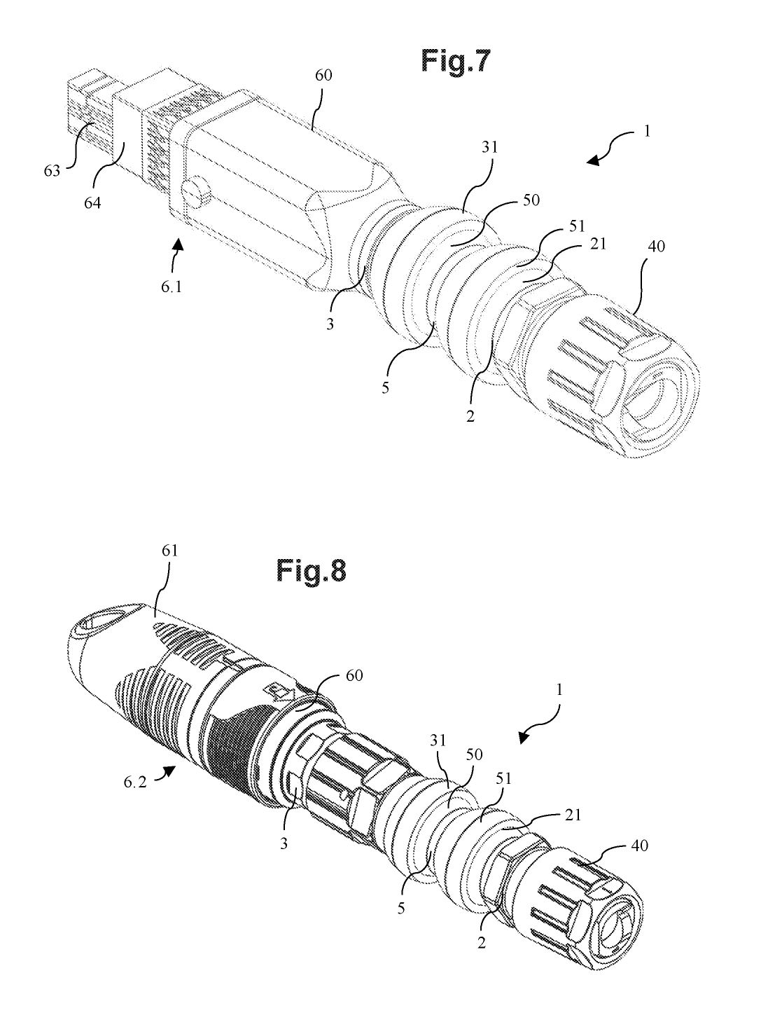

FIG. 7 is a perspective view of an optoelectronic converter connector plug intended to be linked to a cable, and the body of which is integral with the connector joint part of an extension piece with the gland thereof according to the invention;

FIGS. 8 to 10 are perspective views of other connector types which are intended to be each linked to a cable, and the body of which is fixed by screwing to the connector joint part of an extension piece with the gland thereof according to the invention;

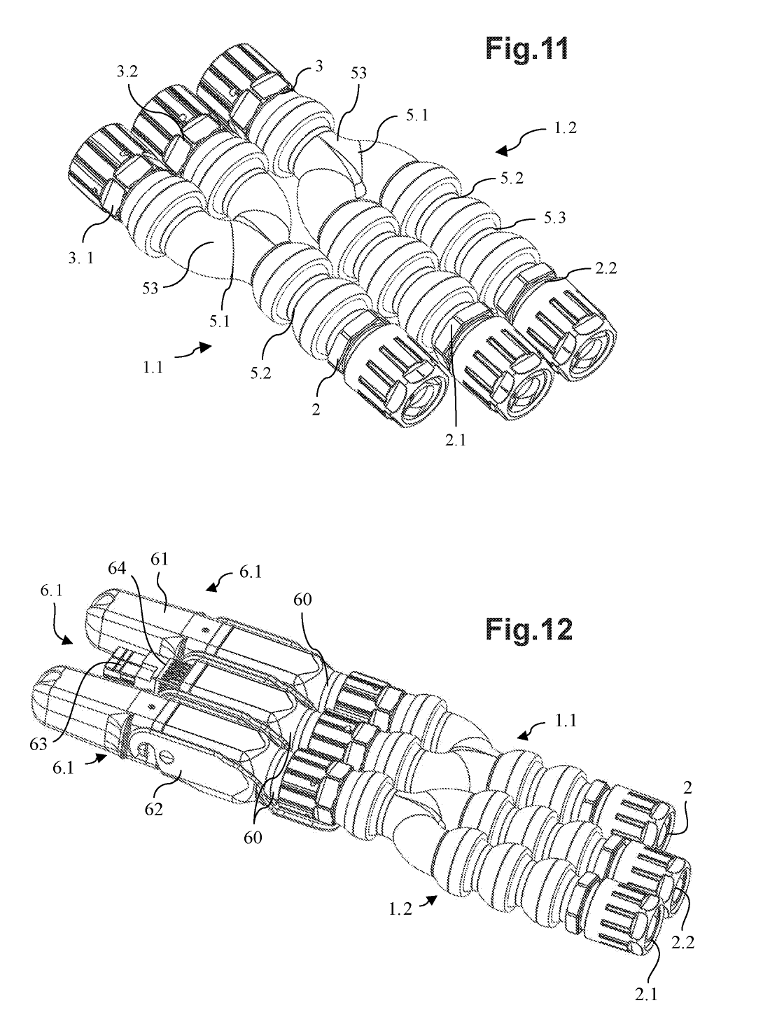

FIG. 11 illustrates a perspective view of extension piece examples according to the invention with the Y-shaped component alternative as in FIG. 5;

FIG. 12 is a perspective view of a connector or of a set of connectors with the extension pieces according to FIG. 11;

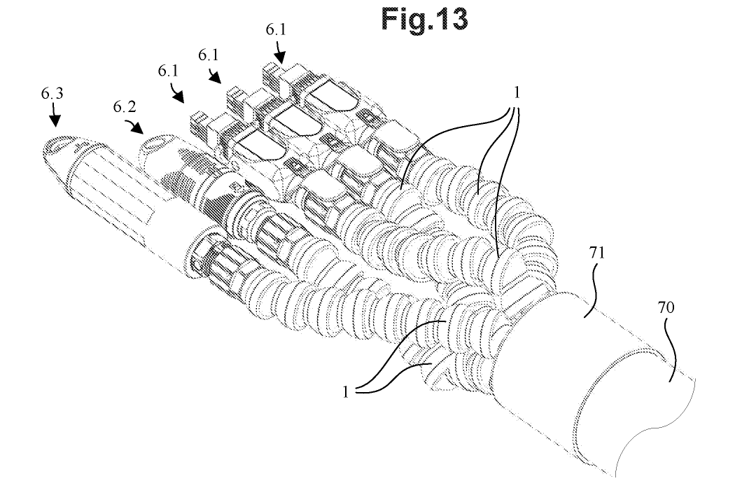

FIG. 13 is a perspective view of a set of connectors of various types, each with an extension piece according to the invention, the extension pieces linked to the cable by a sheath.

The extension piece 1 according to the invention is a cable joint 4 articulated extension piece for a connector 6 linked to at least one cable 7.

As illustrated in FIG. 1, in the embodiment of the extension piece with the least number of pieces, the extension piece 1 comprises two components 2, 3 articulated with respect to one another by a ball joint.

The first component 2 comprises a cable joint part 20 in the form of a conduit suitable to be crossed in a sealed manner by the cable 7 while protecting the cable with respect to the outside, and an articulation part 21 made up by a sphere portion formed integrally or fixed to the conduit 20 of the cable joint.

The sphere portion 21 has a through-passage 22 made therein for the cable as a continuation of that of the conduit 20.

The second component 3 comprises a connector joint part 30 suitable for being formed integrally or fixed with the connector body 60 and an articulation part 31 made up by a sphere portion formed integrally or fixed to the connector joint part.

The sphere portion 31 has a through-passage 32 made therein for the cable.

To produce the ball connection of the articulated extension piece 1, the sphere portions 21, 31 are assembled with one another, by means of force-fitting.

In the embodiment of FIGS. 2, 3, 3A and 3B, the articulated extension piece 1 comprises an additional component 5 which increases the length of the articulated extension piece 1 and adds an additional ball joint thereto.

More precisely, the additional component 5 comprises two articulation parts 50, 51 each made up by a sphere portion integrally formed from the same piece.

A first assembly by means of fitting is thus carried out between the sphere portion 21 of the component 2 and the sphere portion 51 of the additional component 5 in order to form a first ball joint.

A second assembly by means of fitting is carried out between the sphere portion 31 of the component 3 and the sphere portion 50 of the additional component 5 in order to form a second ball joint.

Several elements 5 may be fitted together in succession depending on the length desired for the extension piece.

Thus, the extension piece 1 of FIGS. 2 to 3B, which is made up of the three components 2, 3, 5, is articulated with two ball joints.

When the articulated extension piece 1 is fixed on the body 60 of the connector, it is possible to provide the connector joint part 30 of the component 3, which connector joint part is provided to this end with a threading 33. As shown in FIG. 3A, this threading may be an inner threading 33 which will be screwed onto an outer threading, not shown, of the connector 6 body 60 in order to produce the desired fixing.

To produce the gland 4 which engages the extension piece 1 according to the invention, it is possible to provide the cable joint part 20 of the component 2 with an outer threading 23 on which a nut 40 with the complementary inner threading 41 is screwed, as shown in FIG. 3A.

Beforehand, a first split seal 42 and a split ring 43 are positioned around the cable 7. As shown in FIG. 3A, the arrangement of the seal 42 and of the ring 43 which are held between the part 20 of the component 2 and the nut 40 makes it possible, when screwing on the latter, to swell the seal 42 radially inward and thus both mechanically retain the cable 7 and provide sealing around the sheath 70 thereof.

For each ball joint, it is preferable to provide sealing at the interface between male and female sphere portions.

FIG. 3B illustrates a solution that is simple to implement and effective for producing this sealing: the female sphere portion 31 is made up of two spherical caps 34, 35 which are mutually assembled holding an angular seal 36 which bears against a surface of the male sphere portion 50.

As shown in FIG. 3B, the two caps 34, 35 may be assembled together via latching, wherein one and/or the other of the two caps may bear complementary latching protuberances 37 and/or hollows. Thus, the cap 35 under the form of a ring is clipsed on and around the cap 34.

According to this alternative, for assembly per se of the ball joint with insertion of the seal 36, it is possible to proceed in two different manners.

The first manner consists in inserting and holding the seal 36 between the two caps 34, 35, then in assembling the latter with one another, particularly by latching, then finally in force-fitting the male sphere portion 50 into the female sphere portion 31.

Alternatively, it is possible to fit the male sphere portion 50 into the cap 34, then insert the seal around the male sphere portion 50 and finally fix the caps 34, 35 together holding the seal inserted therebetween, thus forming the female sphere portion 31 as a ball joint around the male sphere portion 50.

Alternatively, the two pieces 34 and 35 may be made as a single monobloc piece and the seal 36 may be embedded in the groove provided by deformation or overmolded in the monobloc piece. Likewise, the male sphere portion 50 is then embedded by deformation in the female portion 31.

As shown on FIGS. 3C and 3D, the assembly between the two caps 34, 35 may be achieved by screwing the cap 35 around the cap 34.

To that end, the cap 34 has an interior thread 340 adapted to cooperate by screwing with the exterior thread 350 of the ring 35.

Advantageously, it is provided to achieve a lock between the ring 35 and the cap 34, once the screwing has been made. Thus, the ring 35 has, on its exterior periphery, a locking notch 351 adapted to cooperate by notching with one of complementary reliefs 341 provided at the end of the cap 34.

According to this variant, the ring 35 is preferably split, which allows to locate initially the ring 35 in the space with reduced diameter around the male portion of sphere 50, for example between this latter and the sphere portion 51 which is adjacent.

The assembly is achieved as follows.

The male portion of sphere 50 is fitted into the cap 34.

Then, the ring 35 is screwed on and around the cap 34 by the intermediate of the complementary threads 340, 350.

When the locking notch 351 is notched with one of the complementary threads 341, the whole formed by the cap 34 and the ring 35 is definitively solidary, and the locking, such as made, guarantees that the ring 35 cannot be unscrewed, and whatever the rotation of the sphere portion 50.

FIG. 4 shows a connector 6 plug linked to a cable 7 with an articulated extension piece according to the invention 1 having three components 2, 3, 5 which is fixed by screwing to the rear of the body 60 of the connector 6. The front part of this plug 6 may include means for removably holding an SFP/SFP+-type optoelectronic converter, or an RJ45-type interface or a power or signal interface of one or more optical contacts.

As illustrated, the plug 6 has a front part mechanically protected before use by a cover 61 latched onto the body 60. It further includes a locking lever 62 having hooks in order to lock it to an electronic equipment receptacle. For more detail, it will be possible to advantageously refer to EP3267232 European patent application.

FIG. 5 illustrates an advantageous alternative according to which an additional component of the extension piece may comprise three articulation parts 50, 51.1, 51.2 or 50.1, 50.2, 51 which are linked to one another by a linking part 53 in the general shape of a Y. This may be a multiple shape when the number of outlets or inlets is greater than two.

Thus, as shown on the left-hand side in FIG. 5, the front sphere portion 50 may be articulated as a ball joint with a complimentary portion which may be the sphere portion 31 of a component 3 and the two rear-sphere portions 51.1, 51.2 may be each linked to a complimentary sphere portion which may be directly that of a component 2.

Conversely, as shown on the right-hand side in FIG. 5, the rear sphere portion 51 may be articulated as a ball joint with a complimentary portion which may be the sphere portion 21 of a component 2 and the two rear sphere portions 50.1, 50.2 may each be linked to a complimentary sphere portion which may be directly that of a component 3.

All of the complimentary sphere portions of the articulated extension piece 1 according to the invention may be assembled with one another such as to be able to have a ball that is completely free in all directions.

It is also advantageously feasible to provide the possibility of rotationally blocking, with respect to one another, the complimentary sphere portions according to one or more swiveling positions.

FIG. 6 shows this possibility: the male-type sphere portions 20, 50 of the various components 2, 3, 5 comprise, on the outer periphery thereof, blocking recesses 28, 58 which engage, according to several swiveling given positions, the blocking tabs 39, 59 provided on the female sphere portions 31, 51.

In other words, when a female sphere portion 31, 51 is oriented in a swiveling given position with respect to the male sphere portion 20, 50 around which it is fitted, the tabs 39, 59 are inserted into the recesses 28, 58 and thus block one of the rotating directions of the ball joint with respect to one another.

This system for partially blocking the ball does not change the performances of sealing provided by the seal 36, 56 since the recess/tab fitting zone is located at the end of the female sphere outside the zone of the seal.

FIG. 7 illustrates an alternative according to which the component 3 forms a single piece with the body 60 of the connector 6. In other words, the connector joint part 30 is integral with the body 60.

FIG. 7 also shows a connector example for which the articulated extension piece according to the invention 1 may be suitable: in this case it is a connector 6.1 plug having an optoelectronic converter 63 and a protective ring 64 for protecting against electromagnetic interference (EMI).

FIG. 8 illustrates another connector example, for outdoor use, for which the articulated extension piece according to the invention 1 may be suitable: in this case it is a push-pull-type connector 6.2 plug.

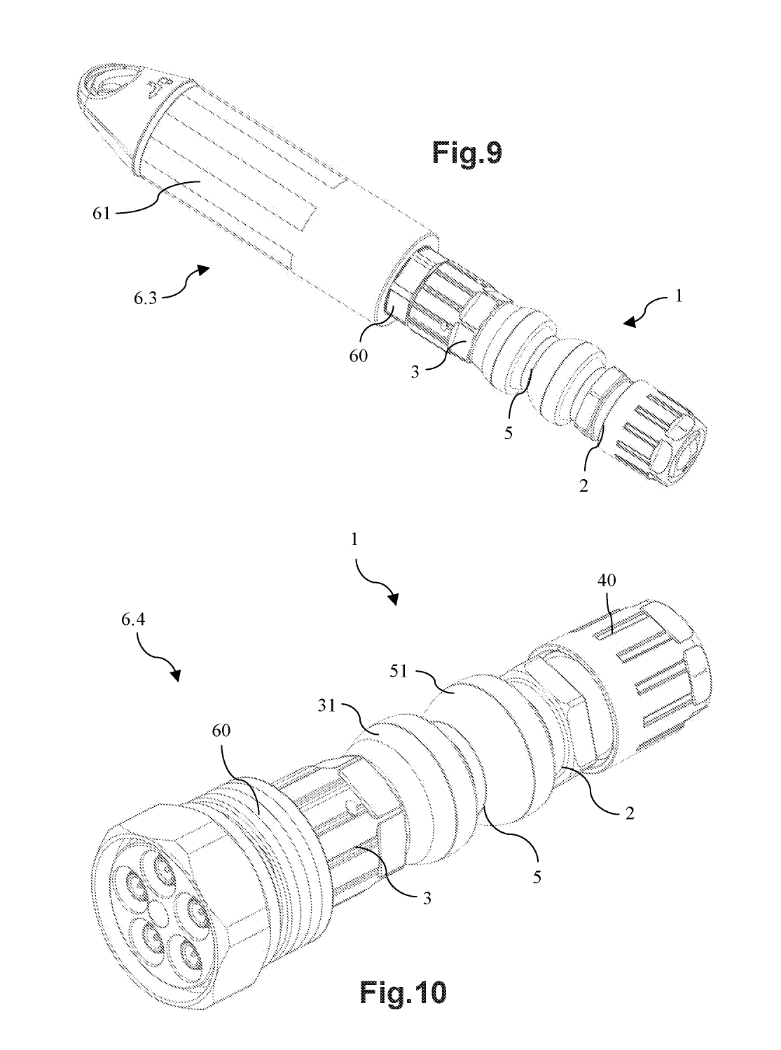

FIG. 9 further illustrates another connector example, for outdoor use, for which the articulated extension piece according to the invention 1 may be suitable: in this case it is a bayonet connector 6.3 plug.

FIG. 10 further illustrates another connector example for which the articulated extension piece according to the invention 1 may be suitable: in this case it is a coaxial 6.4 connector 6.3 plug.

FIG. 11 illustrates alternative embodiments of a connection piece 1 with additional components 5, including a Y-shaped component as shown in FIG. 5.

More precisely, the articulated extension piece 1.1 on the left-hand section of FIG. 11 comprises two additional components 5.1, 5.2 with the front component being Y-shaped and therefore making it possible, using a cable joint with a single cable or cable group, to separate them in two for linking via the two components 3.1, 3.2 to two separate connectors.

The articulated extension piece 1.2 on the right-hand section of FIG. 11 comprises three additional components 5.1, 5.2, 5.3 with the front component being Y-shaped and therefore making it possible, using two cables or cable groups separated with the two components 2.1, 2.2, to join them in order to be linked in a single connector.

FIG. 12 reuses the extension pieces 1.1, 1.2 of FIG. 11 and show the linking thereof to the connectors 6.1 as is described above. Extension pieces 5 may be added as required in an independent manner according to the arms 2, 2.1 and/or 2.2.

Finally, FIG. 13 shows a set of connectors of various types, 6.1, 6.2, 6.2, each linked to an extension piece 1 according to the invention, all of the extension pieces 1 being articulated in a different manner due to the various ball joints thereof in order to be inserted into a single sheath 70 for cables or a group of cables. The function of joining to the cable is provided in this example by a sheath 71 on the cable 70.

Other alternatives and advantages of the invention may be produced without however departing from the scope of the invention.

For example, if, in all of the illustrated examples, the sphere portion 31 of the component incorporated in or fixed to the connector body is of female type insofar as a male sphere portion 50, 21 is fitted therein in order to form a ball joint, it is indeed possible to envisage having a male sphere portion 31 which engages a female portion.

Conversely, if, in all of the illustrated examples, the sphere portion 21 of the component supporting a cable joint part is of male type, it is indeed possible to envisage having a female sphere portion 21.

Generally, all of the male/female combinations may be envisaged for the various components of the extension piece according to the invention.

The invention is not limited to the examples that have been described above; in particular, it is possible to combine, with each other, features of the illustrated examples within non-illustrated alternatives.

1. A device forming a cable joint extension piece for a connector intended to be linked to at least one electrical and/or optical cable, the device comprising:
a first component comprising a cable joint part forming a conduit suitable for a cable to pass therethrough in a sealed manner while protecting the cable with regard to the outside, and an articulation part made up by a sphere portion formed integrally or fixed to the conduit of the cable joint,
a second component comprising a connector joint part suitable to be formed integrally or fixed with a connector body and an articulation part made up by a sphere portion formed integrally or fixed to the joint part,
wherein:
the sphere portions of the first and second components each internally define a through-passage for the cable;
the sphere portions of the first and of the second component are each assembled by fitting with a complementary sphere portion of a component of the extension piece, to produce at least one ball joint between the cable joint part of the first component and the connector joint part of the second component.

2. An extension piece according to claim 1, wherein the cable joint part is configured as a gland of the extension piece.

3. An extension piece according to claim 1, wherein the first component comprises, on the outer periphery thereof, a threading for screwing on the locking ring of the cable joint.

4. An extension piece according to claim 1, wherein the connector joint part of the second component comprises, on the inner periphery thereof, a threading for screwing the second component directly onto the connector body.

5. An extension piece according to claim 1, the sphere portions of the first and of the second component being assembled by fitting directly with one another.

6. An extension piece according to claim 1, comprising at least one third component comprising at least two articulation parts which are each made up by a sphere portion formed integrally or fixed to one another, the sphere portion of the first component being assembled by fitting directly with a sphere portion of at least one third component in order to form a ball joint, the sphere portion of the second component being assembled by fitting directly with a sphere portion of at least one third component in order to form another ball joint.

7. An extension piece according to claim 6, wherein the third component comprising at least three articulation parts linked to one another by a linking part.

8. An extension piece according to claim 7, wherein the linking part of which has the general shape of a Y.

9. An extension piece according to claim 6, comprising at least two third components, a sphere portion of one of the third components being assembled by fitting directly with a sphere portion of another of the third components in order to form another ball joint.

10. An extension piece according to claim 1, wherein at least one sphere portion is made up of at least two spherical caps assembled together with a seal arranged inside the assembly thereof.

11. An extension piece according to claim 10, wherein each of the two spherical caps comprises latching protuberances and/or hollows, to mutually assemble the caps by latching.

12. An extension piece according to claim 10, wherein each of the two spherical caps comprises threads, to mutually assemble the caps by screwing.

13. An extension piece according to claim 12, one of the two spherical caps, under the form of a ring, comprising a locking notch adapted to cooperate by notching with at least one complementary relief formed in the other of the two spherical caps, so as to lock the screwing, and whatever the rotation of the assembled ball joint.

14. An extension piece according to claim 13, wherein the ring is split.

15. An extension piece according to claim 1, two sphere portions assembled directly with one another by means of fitting being further suitable to rotate freely with respect to one another.

16. An extension piece according to claim 1, two sphere portions assembled directly with one another by means of fitting further comprising protuberances and/or hollows for rotational blocking, to have a rotation blocked according to a given angle of one sphere portion with respect to the other.

17. An extension piece according to claim 1, the components being made from electrically insulating material, preferably again from the same material as that of the connector body.

18. A connector, intended to be linked to at least one cable, comprising a body formed integrally or fixed to the connector joint part of the second component of an extension piece according to claim 1.

19. The connector according to claim 18, intended to be connected to two cables or two separate groups, an articulation part of a third component being assembled directly with the joint part of the second component while being crossed by the two cables or separate cable groups, while each of the other two articulation parts forming the arms of the Y of the third component is crossed by one of the two cables or separate cable groups.

20. A set of connectors, comprising a plurality of connectors according to claim 18, comprising a sheath covering all or some of the components of all of the extension pieces.

21. The set of connectors according to claim 20, comprising at least two connectors, an articulation part of a third component being crossed by a single cable or a single group of cables, whereas each of the other two articulation parts forming the arms of the Y of the third component is assembled directly with the joint part of the second component of one of the connectors, while being crossed by a part of the single cable or of the single group of cables.

22. A method for in situ mounting of a connector with an extension piece according to claim 1, on at least one cable, comprising the following steps:
a. threading the cable or cables inside the components of the extension piece;
b. connecting the central contacts of the cable with those of the connector;
c. where required, fixing the joint part of the second component to the body of the connector;
d. producing the cable joint using the cable joint part of the first component of the extension piece.
